(19) United States
(12) Patent Application Publication
(10) Pub. No.: US 2008/0273234 A1
(43) Pub. Date: Nov. 6, 2008

(54) System and method for integrated, analog mode mirror devices

(75) Inventors: David Joseph Mehrl, Plano, TX (US); Paul Gerald Barker, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/799,255

(22) Filed: May 1, 2007

(51) Int. Cl. G02B 26/08

(52) U.S. Cl. 359/223; 359/224

(57) ABSTRACT

A system and method for integrated, analog mode mirror devices. A system containing integrated, analog mode mirror devices includes a damped digital micromirror device (DDMD) optically coupled to a light source and positioned in a light path of the light source, and a controller electrically coupled to the DDMD. The damped micromirrors move more slowly than undamped micromirrors, thereby enabling control of the position of the micromirrors by the controller, with the position being in a range of positions between a first stop position and a second stop position. The micromirror may be moved to a position when presented with a drive waveform that has been modulated by a value specifying the position. This enables the specifying and control of the position of the individual micromirrors in the DDMD.

### TECHNICAL FIELD

The present invention relates generally to a system and method for integrated circuits, and more particularly to a system and method for integrated, analog mode mirror devices.

### BACKGROUND

Micro-electro-mechanical systems (MEMS) have been widely used in electronic products. For example, digital micromirror devices (DMD), a digital MEMS that makes use of a large number of positional micromirrors pivoting between two distinct positions (states), have been used as light modulators in projection display systems. The micromirrors of a DMD are moved to either position based on data of an image being displayed, with a first position reflecting light from a light source onto a display plane and a second position reflecting light from the light source away from the display plane.

An ability to position the micromirrors of a DMD at positions other than the two distinct positions may open up the use of the DMD in applications other than displaying images. It may be possible to operate the DMD in an analog mode, wherein the position of the individual micromirrors may be determined by a drive waveform applied to each micromirror. Exemplary applications of an analog mode DMD may be an optical crossbar switch array and/or a programmable multi-channel equalizer for use in communications, an amplitude/phase modulator for use in three-dimensional holographic displays, holographic optical data storage, laser image illumination despeckling, a light modulator for projection display systems, and so forth.

However, individually controlling the position of a large number of micromirrors has required complex circuitry and control systems that have, heretofore, been difficult to integrate into an integrated circuit. For example, a micromirror in a DMD changes state when an electrostatic potential between the micromirror and two underlying electrodes are such that the resulting electrostatic attraction moves the micromirror from a first position to a second position. When the micromirror changes position, the micromirror typically moves rapidly, making control of the position of the micromirror between the first and second positions a difficult proposition, especially when compounded by the thousands of micromirrors typically present in a DMD.

### SUMMARY OF THE INVENTION

These and other problems are generally solved or circumvented, and technical advantages are generally achieved, by embodiments of a system and method for integrated, analog mode mirror devices.

In accordance with an embodiment, a method for controlling a position of a micromirror is provided. The method includes receiving a value, wherein the position of the micromirror is based on the value, determining a drive waveform based on the value, and providing the drive waveform to the micromirror. The position lies between a first stop position and a second stop position.

In accordance with another embodiment, a system is provided. The system includes a damped digital micromirror device (DDMD) optically coupled to a light source and positioned in a light path of the light source, the DDMD comprising an array of micromirrors operating in a damping liquid, wherein the damping liquid retards the movement of the micromirrors, and a controller electrically coupled to the DDMD. The controller provides drive waveforms to individual micromirrors in the DDMD, wherein a drive waveform moves the micromirrors in the DDMD to a position between a first stop position and a second stop position.

In accordance with another embodiment, a method of manufacturing a system is provided. The method includes installing a light source, installing an optics system optically coupled to the light source and in a light path of the light source, installing a damped digital micromirror device (DDMD) optically coupled to the optics system and in the light path after the optics system, wherein the DDMD comprises an array of micromirrors operating in a damping liquid, and installing a controller electrically coupled to the DDMD.

An advantage of an embodiment is that the use of a damping liquid in the DMD may slow the movement of the micromirrors so that their position may be precisely controlled. Smaller angular changes in position may result in a reduction of the overall movement of the micromirrors, thereby reducing the impact of the slower micromirror transitions.

A further advantage of an embodiment is that the use of a damping liquid may help to reduce or eliminate static friction (stiction) when the DMD is operating in a digital bi-stable mode. A reduction in stiction may help to improve the performance of the micromirrors, for example, by decreasing state transition times, reducing the magnitude of the electrostatic potential required to initiate the transition of the micromirror, and so forth.

Yet another advantage of an embodiment is that a damping liquid's increased index of refraction when compared to air or a vacuum may permit the use of DMDs with reduced angular travel, thereby potentially reducing the impact of the slower micromirror transitions. Alternatively, DMDs with the same amount of angular travel may be used with an increased contrast ratio, since the increased index of refraction may enhance the effect of the tilt angle of the micromirrors, which may help to improve image quality.

In yet another advantage of an embodiment is that the use of a damping liquid with a high dielectric constant can permit the use of lower electrical signal voltage levels, thereby eliminating the need for some circuitry providing elevated voltage levels.

Yet a further advantage of an embodiment is that the analog operation of the DMD may enable the use of the DMD in a wide range of applications (other than image display devices), which may increase demand for DMDs.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1a is a diagram of cross-sectional view of an exemplary digital micromirror device;

FIG. 1b is a diagram of an isometric view of an exemplary digital micromirror device;

FIG. 1c is a diagram of an exemplary digital micromirror device in motion;

FIG. 2 is a diagram of forces operating on a micromirror to bring the micromirror into motion and opposing micromirror motion;

FIG. 3a is a diagram of typical micromirror positions;

FIG. 3b is a diagram of a data plot of micromirror settling times;

FIGS. 4a and 4b are diagrams of the effect of air and a damping liquid on the tilt angle of a micromirror;

FIGS. 5a and 5b are diagrams of side and top views of a sag/piston mode micromirror;

FIGS. 6a through 6c are diagrams of exemplary systems utilizing damped digital micromirror devices and an exemplary feedback control system;

FIG. 7a is a diagram of exemplary micromirror geometry;

FIG. 7b is a diagram of a drive circuit;

FIGS. 8a and 8b are diagrams of algorithms for use in modulating a drive waveform;

FIGS. 9a through 9c are diagrams of different techniques for modulating a drive waveform;

FIGS. 10a through 10d are diagrams of micromirror response and modulated drive waveforms for different exemplary gray scales;

FIG. 11 is a diagram of an algorithm for use in moving a micromirror based on a gray scale;

FIG. 12 is a diagram of a digital micromirror device operating in a mixed mode; and

FIG. 13 is a diagram of a sequence of events in the manufacture of a display system.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a digital micromirror device, wherein the micromirrors of the digital micromirror device are operating in a damping liquid. The invention may also be applied, however, to other light modulators, such as deformable mirrors, operating in a damping liquid. The invention may also be applied to other types of MEMS, wherein operation in a damping liquid may enable more precise control of the moving members of the MEMS by slowing the movements of the moving members, thereby potentially improving the overall performance of the MEMS.

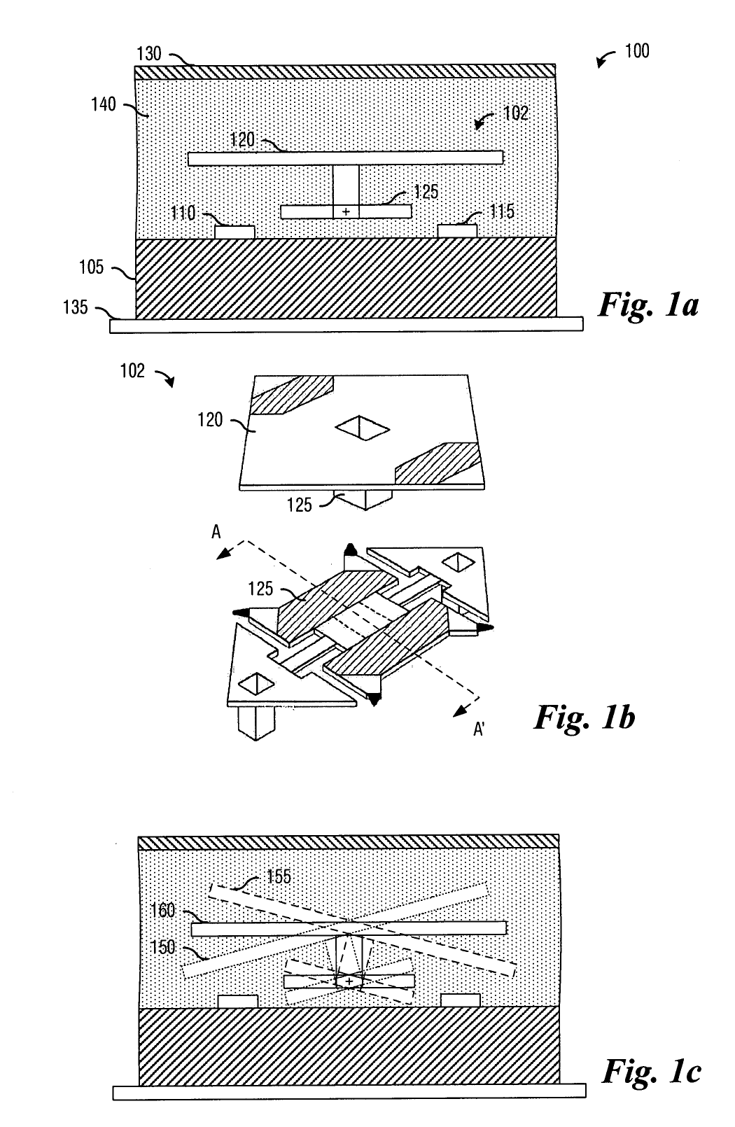

FIG. 1a illustrates a view of cross-section of a DMD 100, with the diagram showing a micromirror 102 of the DMD 100. The DMD 100 includes an integrated circuit formed on a substrate 105. Formed on the substrate 105 may be a first electrode 110 and a second electrode 115. Other parts of the DMD 100, such as electrical conductors, addressing lines, and so forth may not be shown in FIG. 1a. The DMD 100 also includes a reflective surface 120 and a portion of a mounting structure 125. The reflective surface 120 and the portion of a mounting structure 125 may make up the micromirror 102 of the DMD 100. Depending on the implementation of the DMD 100, the reflective surface 120 may pivot on a hinge that may be a part of the mounting structure 125 or both the reflective surface 120 and the mounting structure 125 may pivot on a hinge. The embodiment shown in FIG. 1a illustrates an implementation wherein both the reflective surface 120 and the mounting structure 125 pivots on a hinge.

The reflective surface 120 (and the mounting structure 125) may either pivot towards the first electrode 110 or the second electrode 115, depending on an electrostatic potential between the reflective surface 120 and the first electrode 110 and the second electrode 115. For example, if the electrostatic potential between the reflective surface 120 and the first electrode 110 is greater in magnitude than the electrostatic potential between the reflective surface 120 and the second electrode 115, then the reflective surface 120 may be attracted to and may pivot towards the first electrode 110.

The DMD 100 may include a cap 130, which is preferably optically clear to the wavelength(s) of light passing through the cap 130. The cap 130 may also be referred to as a lid. The cap 130 may be used to seal the integrated circuit portion of the DMD 100 in a package 135 and may be permanently fixed to the package 135. The space between the integrated circuit portion of the DMD 100 and the cap 130 may be filled with a damping liquid 140. Alternatively, the space between the integrated circuit portion of the DMD 100 and the cap 130 may be filled with air, a vacuum, a gas, or so forth. FIG. 1b illustrates an isometric view of the micromirror 102 of the DMD 100, with the view shown in FIG. 1a being along line A-A′ made in the micromirror 102.

In normal operation, the micromirror 102 may be in one of two positions, as shown in FIG. 1c. The micromirror 102 may be in a first position 150 or a second position 155 or in a transition to either the first position 150 or the second position 155. When not in normal operation, the micromirror 102 may be in a rest position 160.

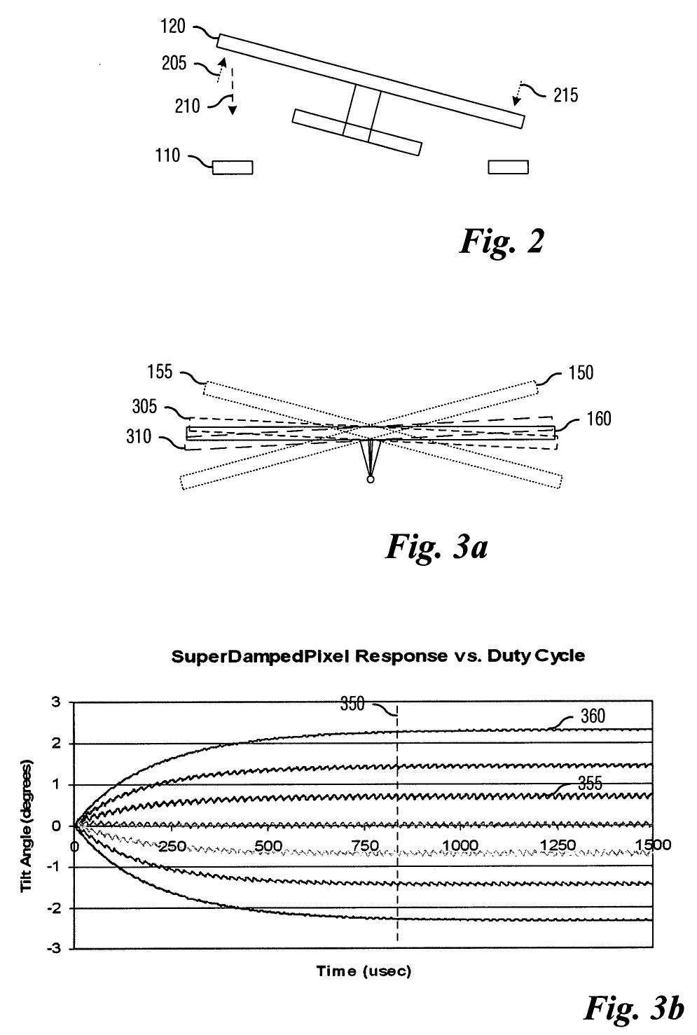

As the micromirror 102 transitions to either the first position 150 or the second position 155, the damping liquid 140 may offer a level of resistance to the movement of the micromirror 102. For example, as shown in FIG. 2, if the reflective surface 120 of the micromirror 102 is transitioning from the second position 155 to the first position 150 due to the greater electrostatic potential between the reflective surface 120 and the first electrode 110 than the electrostatic potential between the reflective surface 120 and the second electrode 115, the damping liquid 140 may offer a force (shown as vector 205) that pushes against the reflective surface 120 in a direction opposite to a force (shown as vector 210) that is pulling the reflective surface 120 towards the first electrode 110. A similar but opposite force (shown as vector 215) may be operating on the opposite end of the reflective surface 120.

A wide variety of liquids (and potentially some gasses) may be used as a damping liquid. A damping liquid may be selected based on its viscosity and/or dielectric constant. For example, a damping liquid with a viscosity that is greater than that of air may slow the movement of micromirrors of a DMD. Additionally, a damping liquid with a dielectric constant that is greater than that of air may reduce the electrostatic potential required to cause micromirrors to move, thereby reducing the voltage needed to effect a transition of a micromirror. The decreased voltages needed to effect a transition of a micromirror may enable the use of more mainstream integrated circuit processes, such as CMOS processes, which may be further developed and may allow greater circuit densities, smaller transistor sizes, and so forth. The use of manufacturing processes allowing greater circuit densities may allow for the creation of denser DMD arrays and/or the inclusion of more sophisticated circuitry without incurring a significant size penalty.

The following is a table displaying the viscosity (in Poise) of exemplary gasses.

| Gas | Viscosity | Relative Viscosity (to air) |
|---|---|---|
| Air | 0.00018 | 1.0 |
| Helium | 0.00019 | 1.055 |
| Methane | 0.00020 | 1.111 |
| Nitrogen | 0.00018 | 1.0 |
| Oxygen | 0.00020 | 1.111 |

The following is a table displaying the viscosity (in Poise) of exemplary liquids.

| | | Relative |
|---|---|---|
| Liquid | Viscosity | Viscosity (to air) |
| Acetone | 0.0032 | 18 |
| Water | 0.01 | 55.5 |
| Ethyl Alcohol | 0.012 | 67 |
| Benzyl Ether | 0.0533 | 300 |
| Ethylene Glycol | 0.199 | 1105 |
| Glycerine | 14.9 | 8277 |
| Oil (light) | 11 | 6111 |
| Fluorinert | 0.008 | 44.4 |
| Ethyl Acetate | 0.423 | 32 |
| Octane | 0.508 | 38 |
| Methanol | 0.544 | 41 |
| Ethanol | 1.074 | 67 |
| 1, Octanol | 7.288 | 548 |
| 1,2 Propylene Glycol | 40.4 | 3038 |
| Tetrachlorosidane | 99.4 | 7474 |
| Glycerol | 938 | 70526 |

The following is a table displaying relative dielectric constants and effective landing voltages of exemplary liquids and gasses. The landing voltages are for one particular type of exemplary DMD. Other forms and/or implementation of DMDs may have different landing voltages.

| Liquid/Gas | εᵣ | Effective landing voltage |
|---|---|---|
| Air | ~1 | 19 v |
| Ethyl acetate | 6.05 | 7.72 v |
| Dichloro methane | 8.92 | 6.36 v |
| Methanol | 33.2 | 3.3 v |
| Deionized water | 79.3 | 2.13 v |

In addition to damping the motion of the micromirror of a DMD and enabling the use of lower voltages to initiate movements of the micromirror, the use of a damping liquid may enable the use of a DMD in applications involving the use of light in the ultraviolet and/or x-ray spectrum, such as photolithography used in integrated circuit manufacturing. The selection of a proper damping liquid can enhance the operation of DMDs with short wavelength light.

FIG. 3a illustrates a comparison of micromirror positions. As discussed previously, a micromirror of a DMD operating in a digital mode may come to rest in one of two positions, a first position 150 and a second position 155. The first position 150 and the second position 155 are about +/−12 degrees from a rest position 160. The rest position 160 may correspond to a position of a micromirror of a DMD when the DMD is powered off.

In a DMD operating in a digital mode, micromirrors rapidly flip between the first position 150 and the second position 155 based on image data. The operation of the DMD depends on the physiology of the human visual system to perform as a temporal low-pass filter to create differing gray (or color) levels rendered by varying a duty cycle of the micromirrors. In an embodiment, a damping liquid, such as the damping liquid 140, may severely dampen the motion of micromirrors, such as the micromirror 102, so that the damping liquid 140 may function as temporal low-pass filters, permitting the micromirror 102 to achieve a wide range of steady state tilt angles. For example, in the diagram shown in FIG. 3a, the micromirror 102 may be able to achieve a steady state tilt angle of about +/−3 degrees (shown as a first steady state position 305 and a second steady state position 310) from the rest position 160. Although shown with a steady state tilt angle of about +/−3 degrees, the micromirror 102 may be able to achieve any steady state tilt angle between the two micromirror positions of a DMD operating in a digital mode (the first position 150 and the second position 155) of a typical DMD. The damped micromirror 102 may also be able to move to the first position 150 and the second position 155.

Although the damping liquid 140 may slow the transition time of the micromirror 102, the temporal low-pass filtering of the damping liquid 140 may eliminate the need for the large number of full swing transitions of the micromirror 102. For example, to achieve a 60 percent gray scale, a typical DMD operating in a digital mode may position its micromirrors in the first position 150 sixty (60) percent of the time and in the second position 155 forty (40) percent of the time. However, with the use of the damping liquid 140 the micromirrors in the DMD may be brought to a tilt angle that may be dependent on characteristics of illumination optics and collection optics of a display system utilizing the damped DMD, with a monotonic relationship between gray scale and tilt angle. Once moved to the tilt angle, the micromirrors may be held in a relatively constant position and may not have to move again until there is a desire to move the micromirrors.

The data plot shown in FIG. 3b illustrates a simulation of micromirror tilt angle versus time (in microseconds) for an exemplary DMD. To achieve a desired tilt angle for a micromirror, a micromirror drive waveform that corresponds to the desired tilt angle may be applied to the micromirror. The micromirror drive waveform may be applied to the micromirror until the micromirror achieves the desired tilt angle. The micromirror drive waveform then may be maintained indefinitely or until there is a desire to move the micromirror to a different tilt angle. The data plot shown in FIG. 3b shows that a transition time from a rest position, such as the rest position 160, to a desired tilt angle may be independent of the desired tilt angle. A time required for a micromirror to transition to a desired tilt angle remains substantially consistent at about 800 microseconds (shown as vertical line 350) as the desired tilt angle varies from about +/−0.5 degrees (with +0.5 degrees shown as a first trace 355) to about +/−2.5 degrees (with +2.5 degrees shown as a second trace 360).

The use of a damping liquid may also help to reduce a required tilt angle of a micromirror to achieve a desired amount of separation the difference in tilt angles between an on state for a micromirror and an off state for a micromirror. The on state for a micromirror may correspond to a position of the micromirror that reflects light onto a display plane, while the off state for a micromirror may correspond to a position of the micromirror that reflects light away from a display plane. In a display system, a greater amount of separation may tend to increase the contrast ratio of images displayed in the display system, thereby increasing the image quality of the display system. However, the greater the separation, the further the micromirrors have to travel. Therefore, the greater the separation, the longer the micromirror transition times.

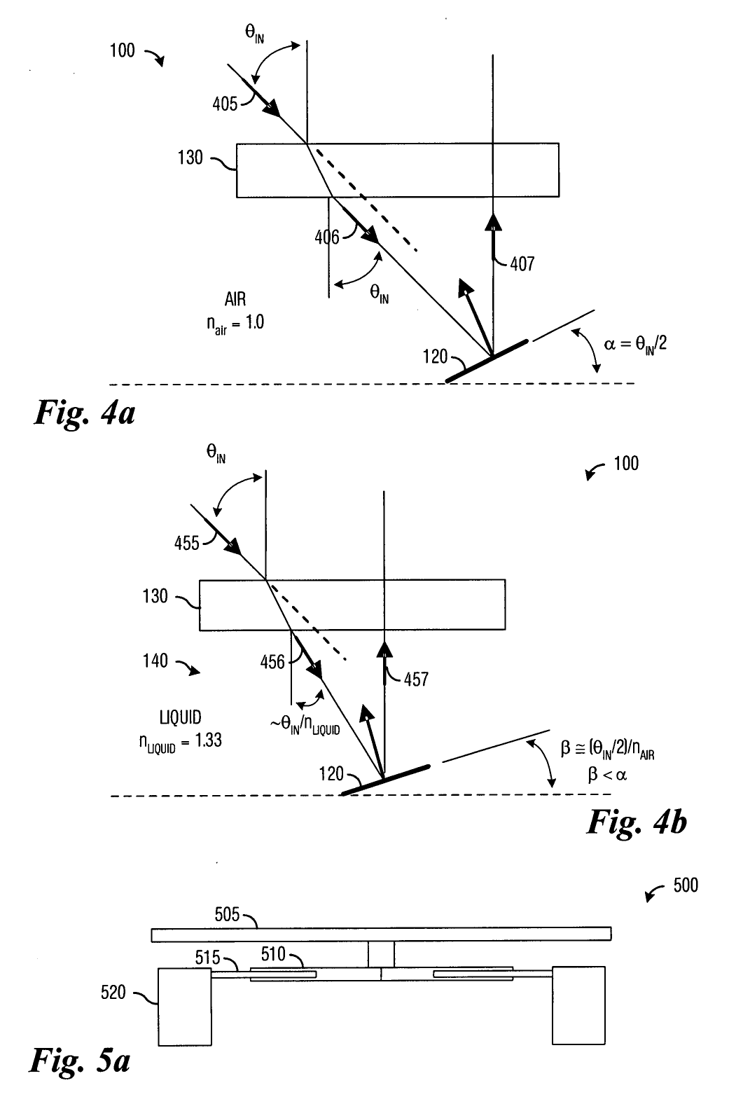

With reference now to FIGS. 4a and 4b, there are shown diagrams illustrating the effect of a damping liquid on the tilt angle of a micromirror of a DMD 100. The diagram shown in FIG. 4a illustrates a path of a light beam 405 as it traverses a DMD 100, wherein micromirrors of the DMD 100 are operating in air with an index of refraction (nₐᵢᵣ) substantially equal to 1.0. The light beam 405 may be incident to the cap 130 with an angle of incidence of about θ_{IN}. As the light beam enters the cap 130, it is bent towards a normal of the cap 130. However, as the light beam 405 exits the cap 130 and reenters air, the light beam 405 is bent back away from the normal of the cap 130 (shown as light beam 406). The exit angle of the light beam 406 is back to about θ_{IN}. The reflective surface 120 of a micromirror of the DMD 100 may be set at an angle α, wherein α is about equal to θ_{IN}/2. With θ_{IN} at about 24 degrees, then α is about 12 degrees. The angle α is set so that the light beam 406 will reflect off the reflective surface 120 and exit the DMD 100 at an angle that is about perpendicular to the cap 130 (shown as light beam 407).

The diagram shown in FIG. 4b illustrates a path of a light beam 455 as it travels through a DMD 100, wherein micromirrors of the DMD 100 are operating in a damping liquid 140 with an index of refraction (n_{liq}) substantially equal to 1.33. An example of a damping liquid with an index of refraction of about 1.33 is water. As above, the light beam 455 may be incident to the cap 130 with an angle of incidence of about θ_{IN}. As the light beam 455 enters the cap 130, it is bent towards the normal of the cap 130. However, as the light beam 455 exits the cap 130 and enters the damping liquid 140, the light beam 455 is bent away from the normal of the cap 130 (shown as light beam 456). Rather than being bent back to being substantially equal to θ_{IN}, the light beam 455 is bent back to being substantially equal to θ_{IN}/1.33. The reflective surface 120 of a micromirror of the DMD 100 may be set at an angle β, wherein β is about equal to (θ_{IN}/2)/1.33. If θ_{IN} is about 24 degrees, then β is about 9 degrees. In general, the angle β is (β_{IN}/2)/n_{liq} for the case when n_{liq}>1. Therefore, the interior angle may be reduced by the presence of the damping liquid, and the micromirrors of the DMD 100 may be landed on a smaller landed tilt angle yet still reflect a light beam 456 away from the DMD 100. The light beam 456 will reflect off the reflective surface 120 and exit the DMD 100 at an angle that is about perpendicular to the cap 130 (shown as light beam 457).

In addition to potentially decreasing the tilt angle range of a micromirror, the presence of the damping liquid 140 may help to eliminate or reduce a need for an antireflective coating on the cap 130. When filled with air, an antireflective coating on an underside of the cap 130 may be used to better match the index of refraction between the air (or vacuum) used in the DMD 100 and the material used in the cap 130, typically glass. The presence of the damping liquid 140 may reduce the difference between the index of refraction to an extent such that the antireflective coating may be eliminated, rendered more effective, or a less expensive antireflective coating may be used.

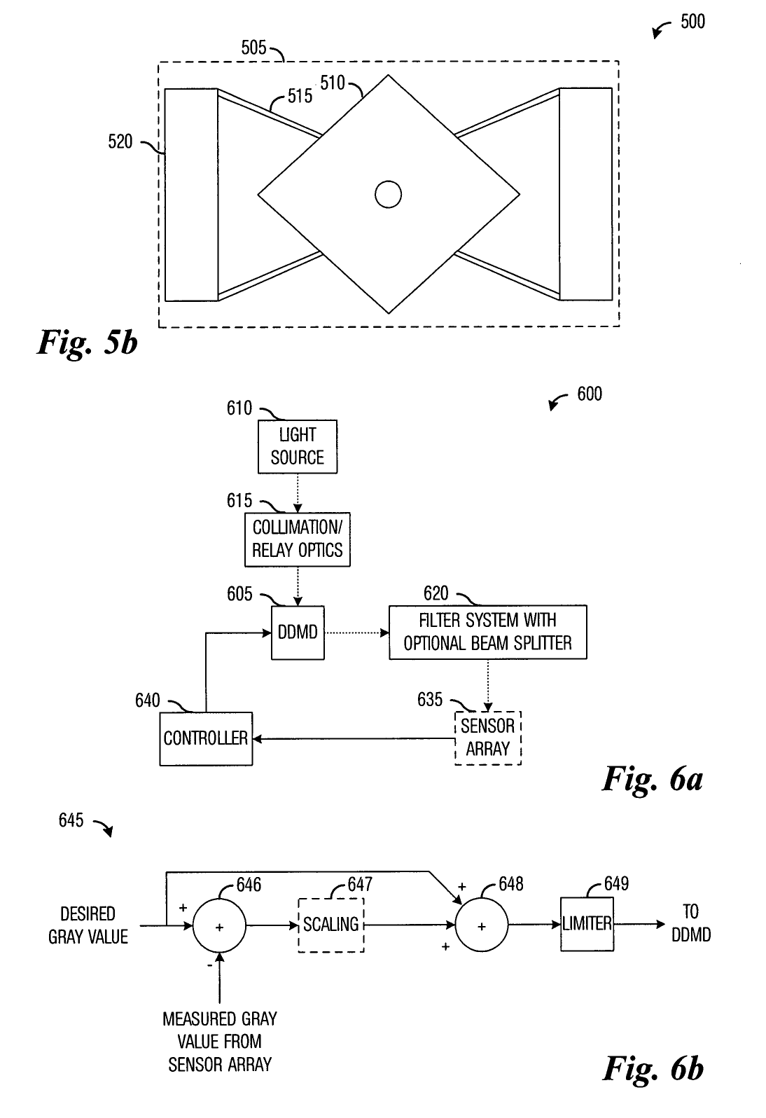

With reference now to FIGS. 5a and 5b, there are shown diagrams illustrating side and top views of a micromirror 500. The micromirror 500 shown in FIGS. 5a and 5b may operate in a different fashion that the micromirror 102 shown in FIGS. 1a through 1c. Rather than tilting, the micromirror 500 operates in a sag/piston mode, wherein a reflective surface 505 moves up and down. The reflective surface 505 may be mounted on a mounting structure 510, which may be mounted via hinges 515 to a hinge support 520. The hinges 515 permit the reflective surface 505 and the mounting structure 510 to move up and down based on an electrostatic potential created between the reflective surface 505 and electrodes formed underneath the micromirror 500. The reflective surface 505 may then be attracted to the electrode and move down towards the electrodes. The diagram shown in FIG. 5b illustrates a top view of the micromirror 500 with the reflective surface 505 displayed as a dashed line to make the underlying structure visible. A number of hinges 515, preferably four or more hinges, permit the reflective surface 505 and the mounting structure 510 the freedom to move up and down while maintaining torsional rigidity.

When operating without a damping liquid, the reflective surface 505 of the micromirror 500 may typically be in one of two positions (states), a first state may be when the reflective surface 505 is positioned at its highest extent when there is little or no electrostatic potential between the reflective surface 505 and the electrodes formed underneath the micromirror 500 and a second state may be when the reflective surface 505 is positioned at its lowest extent when there is maximum electrostatic potential. In addition to being in either of the two states, the reflective surface 505 may be in transition to either of the two states or in a rest state when the micromirror 500 is not in operation.

When operating with a damping liquid, the position of the reflective surface 505 may still remain a function of the electrostatic potential between the reflective surface 505 and the electrodes, however, the up and down movement of the reflective surface 505 may be retarded by the damping liquid. The damping liquid may enable the regulation of the position of the reflective surface 505 at positions in between positions corresponding to the first state and the second state in a manner similar to the way that the tilt angle of micromirrors with tilting reflective surfaces operating in a damping liquid may be regulated.

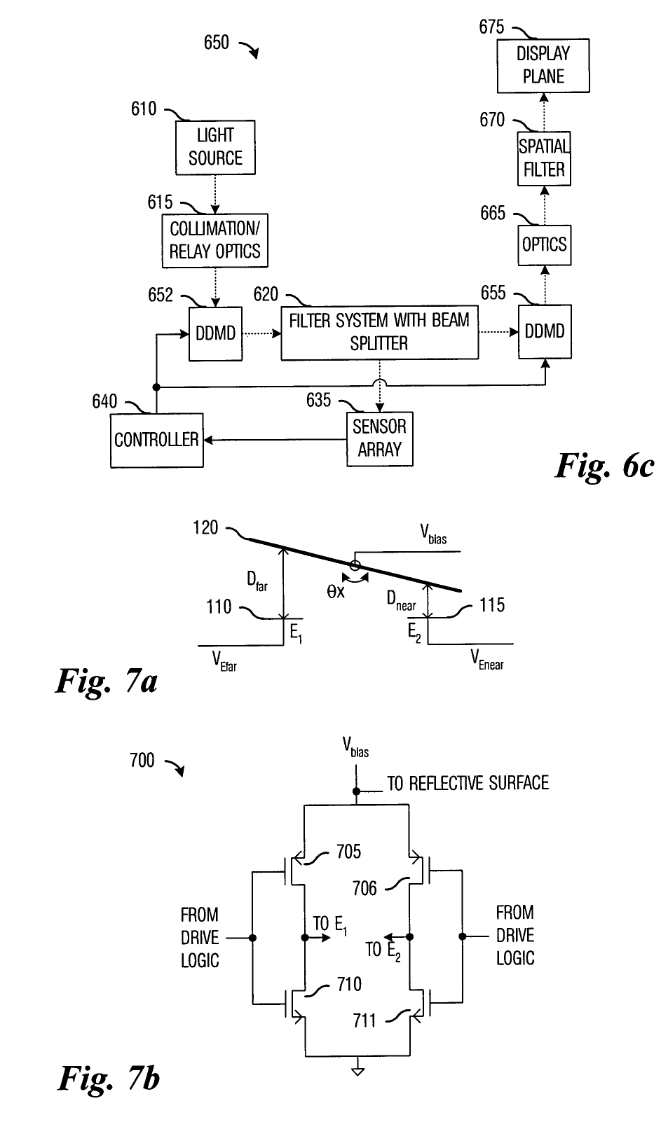

With reference now to FIGS. 6a through 6c, there are shown diagrams illustrating exemplary systems utilizing DMDs, wherein the DMD includes micromirrors operating in a damping liquid. Also shown is an exemplary feedback control system. Many applications exist for DMDs with micromirrors operating in a damping liquid. For example, in telecommunications, such systems may be used as multi-channel programmable optical attenuators and/or crossbar switches. Systems with dampened micromirror DMDs may also be used to direct computer generated hologram (CGH) synthesis for three-dimensional display and/or holographic data storage. Display systems may be created with programmable diffraction grating color filtering, Fourier plane spatial filtering for real-time image processing, and so forth. High-resolution phase modulation systems may also be created using dampened micromirror DMDs. Another example of an application may be with ground based astronomical telescopes, wherein images from an optical telescope may be distorted by convection currents, turbulent effects in the Earth's atmosphere, and so forth. However, optical sensors, such as Hartmann-Shack array detectors may be able to detect the phase of the aberrated wave-fronts. The optical sensors may provide control signals into optical mirror arrays (such as the damped DMDs) to permit real-time correction of the aberrations.

An additional application may be in enhancing image contrast in digital cameras. In a digital camera, the dynamic range of an image may be determined by the brightest object(s) within the field of view. Therefore, if there is a bright object in the field of view, then other objects may need to be underexposed to prevent “blooming” from occurring about the bright object. A damped DMD may attenuate the bright areas within the field of view, permitting the digital camera to increase the image exposure without blooming. Yet another application of damped DMDs may be in the production of flicker free images. Since the damped DMD typically continuously projects light, images taken of damped DMD projected images will not result in artifacts present when unsynchronized images are taken of projected images that are rapidly switched on and off.

The diagram shown in FIG. 6a illustrates a system 600 that includes a single dampened micromirror DMD (DDMD) 605. The DDMD 605 may be a tilt mode micromirror DMD, such as those shown in FIGS. 1a through 1c, or a sag/piston mode micromirror DMD, such as those shown in FIGS. 5a and 5b, for example. The DDMD 605 may be used to modulate light produced by a light source 610. Examples of the light source 610 may be a wideband light source (for example, an electric arc lamp), a narrowband light source (for example, a light emitting diode, a laser diode, or an alternate form of solid state light source), an out-of-visual spectrum light source (for example, an infrared, ultraviolet, x-ray, and so forth, light source), and other light sources.

A collimation/relay optics unit 615 may be used to collect light produced by the light source 610, expand/collimate as necessary, relay light to the DDMD 605, and so on. After modulation by the DDMD 605, the modulated light may be further processed by a filter system with optional beam splitter unit 620. For example, the filter system may be a Schlieren filter system, which may be used to convert light modulated by the tilt angle variations of the DDMD 605 into light with corresponding gray level intensity variations.

Alternatively, the filter system may be a graded neutral density filter having an intensity transmittance that varies with position. For example, a graded neutral density filter may have an intensity transmittance that may be uniform in a +/−Y extent, but may be linearly graded in the +/−X extent so that the filter's intensity transmittance, Σ₁=Iₒᵤₜ/Iᵢₙ, may be defined as τ₁(x,y)=x/W+½, where W is the width of the filter with a left edge of the filter (such as at x=−W/2), the intensity transmittance is about zero (approximately completely opaque) and a right edge of the filter (such as at x=W/2), the intensity transmittance is about unity (approximately completely transparent). The filter may have a linear gradation of translucency between the two edges.

The optional beam splitter may be used to split the modulated light into multiple light paths. For example, if the system 600 is an image display system, then the filter system with optional beam splitter unit 620 may also collimate and diffuse the modulated light to improve image quality. The optional beam splitter may be used in certain applications wherein additional precision is needed. A discussion of such an application is provided below.

Although the performance of the DDMD's thousands of individual micromirrors may be substantially identical certain applications, such as crossbar switches and high-resolution phase modulators, may require an additional degree of precision in controlling the movement of the micromirrors. When additional precision is needed, an optional sensor array 635 may be included in the system 600. The sensor array 635 may make use of one of the multiple light paths provided by the optional beam splitter of the filter system with optional beam splitter unit 620. Examples of the sensor array 635 may be a charge coupled device (CCD) array, a CMOS image sensor array, or other forms of optoelectric converters. The sensor array 635 may convert light from the optional beam splitter into electrical signals that may be provided to a controller 640. The controller 640 may include a feedback control system that may be used to process the electrical signals provided by the sensor array 635 into information related to the position of the micromirrors of the DDMD 605. The controller 640 may then provide instructions, in the form of micromirror drive waveforms, for example, to the DDMD 605 to make adjustments to individual micromirrors as needed.

With reference now to FIG. 6b, there is shown a diagram illustrating an exemplary feedback control system 645. The feedback control system 645 may be a part of the controller 640 or it may be an external circuit coupled to the controller 640. The feedback control system 645 includes an adder 646 configured to compute a difference between a desired gray value that may be used by the controller 640 to generate a micromirror drive waveform to set a desired tilt angle for the micromirrors of the DDMD 605 and a measured gray value provided by the sensor array 635, the difference may be commonly referred to as an error signal. The feedback control system 645 may also include an optional scaling unit 647 that may be used to apply a weight to the error signal produced by the adder 646. The scaling provided by the scaling unit 647 may be a fixed value that may be applied to all error signals or an adaptive value with a value that may change with magnitude of the error signal, time, or so on. For example, the scaling may be maximized during the initial stages of micromirror movement, and then as the micromirror approaches the desired tilt angle, the scaling may be reduced or eliminated.

A second adder 648 may combine the desired gray value and a scaled error signal to produce a feedback adjusted gray value. The output of the second adder 648 (the feedback adjusted gray value) may then be provided to a limiter 649. The limiter 649 may constrain the feedback adjusted gray value so that it remains within a specified range. For example, the limiter 649 may constrain the feedback adjusted gray value to being greater than or equal to zero and less than or equal to 2^{N}−1, where N is the number of bits in the gray value. If the second adder 648 produces a feedback adjusted gray value that is less than zero (i.e., negative), then the limiter 649 may constrain the feedback adjusted gray value to being equal to zero. Similarly, a feedback adjusted gray value that exceeds 2^{N}−1 may be constrained to being equal to 2^{N}−1.

Thus, the limiter 649 may allow the driving of a micromirror to a desired tilt angle with a maximum permitted electrostatic torque when a difference between the desired tilt angle and the micromirror's tilt angle is large. However, as the difference gets smaller, the electrostatic torque used to drive the micromirror may be reduced. The output of the limiter 649 may then be provided to the controller 640. The controller 640 may then generate a micromirror drive waveform from the feedback adjusted gray value (and potentially limited) to be provided to the DDMD 605.

For example, if a micromirror moves to an angle that exceeds the desired tilt angle, then the sensor array 635 may measure that light corresponding to the micromirror may be too light and sends appropriate feedback information to the controller 640. The controller 640 may then adjust a micromirror drive waveform provided to the micromirror with the micromirror drive waveform moving the micromirror to a lower tilt angle. With the adjusted micromirror drive waveform, the micromirror may move to a lower tilt angle and to the desired tilt angle. When the tilt angle of the micromirror is about equal to the desired tilt angle, then the error signal, as produced by the adder 646, is also about zero. Hence the feedback adjusted gray level is about equal to the desired gray level, and therefore, the micromirror drive waveform generated by the controller 640 remains unchanged.

The operation of the feedback control system 645 may be extended to an array and may encompass each micromirror of the DDMD 605. A first array may be used to store desired gray levels, with each entry in the first array corresponding to an individual micromirror. A second array may be used to store the feedback signals provided by the sensor array 635, with each entry in the second array corresponding to an individual micromirror's feedback signal. The first array and the second array may be subtracted to populate a third array, wherein each entry may be used store a computed error signal for each micromirror. The first array and the third array may be combined (potentially after an optional scaling of the third array) to produce a fourth array containing feedback adjusted gray levels for each micromirror. The first array, the second array, the third array, and the fourth array may be logical arrays and an implementation of the embodiment may require a smaller number of actual memory arrays to store the information contained in the four logical arrays. The feedback control system 645 as described above is one simple embodiment. Many other possible embodiments may be possible, including feedback control systems with higher order, more feedback loops, sophisticated control schemes, non-linear systems, and so forth. Feedback control systems are considered to be well understood by those of ordinary skill in the art of the present invention and will not be discussed further herein.

With reference back to FIG. 6a, the system 600 with the optional beam splitter and the optional sensor array 635 may be configured to perform an automatic calibration upon power up or after a reset to create a lookup table, for example, to provide intensity response versus different gray scale levels to be used in the drive waveforms of the DDMD 605. Then, during normal operation, the lookup table may be used in conjunction with an interpolation technique to find an appropriate gray scale level and drive waveform to achieve a desired intensity.

The diagram shown in FIG. 6c illustrates a system 650 with two DDMDs, a first DDMD 652, preferably a tilt-mode DMD, and a second DDMD 655, preferably a sag/piston mode DMD. Other combinations of tilt mode and sag/piston mode DMDs may be possible. The system 650 may be used to create phase and amplitude modulated images, for use in three-dimensional computer generated holograms, for example. The first DDMD 652 may modulate light from the light source 610 after it has been optically processed by the first lens system 615. In this particular implementation, the light source 610 may be a laser. However, other sources of coherent light may be utilized, such as a laser diode or a filtered wideband or narrowband light source. The second lens system 620 may perform additional light processing.

The filter system with beam splitter unit 620 may be used to filter the modulated light produced by the first DDMD 652. The filter of the filter system with beam splitter unit 620 may be implemented as a Schlieren type filter placed at a Fourier plane of the system 650. Alternatively, the filter system may be a phase shift dot filter. The phase shift dot filter may include a small dot of dielectric material having an optical thickness of about λ/4 may be placed on an optical flat. The optical flat may be placed in the Fourier plane of the display system. The filter of the filter system with beam splitter unit 620, which may take various forms ranging from a simple knife edge filter to a graded amplitude filter, may convert the linear phase modulation imparted by the tilt mode micromirrors of the first DDMD 652 to an intensity level variation. The beam splitter of the filter system with beam splitter unit 620 partitions the modulated light (now intensity modulated) into two light beams, and a first light beam may be provided to the second DDMD 655, while a second light beam may be provided to the sensor array 635 to provide micromirror information back to the controller 640 to enable fine tuning of the micromirrors of the first DDMD 652.

The modulated light may be further modulated by the second DDMD 655 and an optics unit 665 may provide additional light processing. A spatial filter 670 may be used to remove extraneous orders of the intensity modulated light. The phase modulation performed by the second DDMD 655 may shape the wavefronts of the light with a periodic device (the sag/piston mode mirrors of the second DDMD 655). Since the mirrors may be periodically spaced, the phase modulation may impart a stair-stepped shape to the wavefronts. The resulting phase modulation may result in light wavefronts also exhibiting the steps, which at the Fourier plane will appear as a multitude of substantially uniformly spaced dots. The spatial filter 670 may be used to suppress some of the higher frequency orders. An output of the spatial filter 670 may be a phase and amplitude modulated image projected on a display plane 675.

A similar optional optical feedback approach could be used with the sag/piston mode DDMD (the second DDMD 655 shown in FIG. 6c). An additional low power laser may be used to illuminate the sag/piston mode DDMD. The additional laser may be oriented on an orthogonal axis with respect a light path of the system 650. The resulting modulated light may be imaged through its own filter stop (a Schlieren type filter, for example) onto a second sensor array which may provide optical feedback to the controller 640 information exclusively for control of the sag/piston mode axis. That axis may be made to be non-coincidental with the main optical axis of the system 650 shown in FIG. 6c, such that the light from the additional laser does not affect the final image at the display plane 675.

A diagram shown in FIG. 7a illustrates a simplified model of a micromirror's geometry. The diagram illustrates a first electrode 110 (labeled ‘E₁’), a second electrode 115 (labeled ‘E₂’), and a reflective surface 120 of a micromirror. For discussion purposes, a near side and a far side are defined for the micromirror. The near side and the far side are defined based upon the tilt angle (θ_{X}) of the reflective surface 120. When the tilt angle is negative (θ_{X}<0), as shown in FIG. 7a, the first electrode 110 is referred to as being a far side electrode and the second electrode 115 is referred to as being a near side electrode. A distance between the far side electrode (the first electrode 110) to the reflective surface 120 may be defined as a far distance. Similarly, a near distance may be defined as a distance between the near side electrode (the second electrode 115) and the reflective surface 120. When the tilt angle is positive (θ_{X}>0) the near side and the far side designations are reversed. If the tilt angle is equal to zero (θ_{X}=0), then either the first electrode 110 or the second electrode 115 may be the near side electrode.

Due to the dielectric constant (∈ᵣ) of the damping liquid 140 typically being higher than the dielectric constant (∈ᵣ) of air, it may be possible to operate the micromirrors of the DDMDs at lower voltages. The use of lower voltages may allow for the use of more standard CMOS technology for driver circuits, eliminating the need for specially designed high voltage driver circuits.

The drive circuit 700 shown in FIG. 7b includes transistors 705 and 706, preferably P-channel MOS transistors, and transistors 710 and 711, preferably N-channel MOS transistors. The far side electrode of a micromirror may be held at voltage V_{bias} (by turning on either the transistor 705 or 706, depending on the electrode). This may be done even as V_{bias} is being ramped up. This may ensure that there is no attraction between the far side electrode and the reflective surface 120.

Then, the near side electrode may be held at ground potential (0 v) by turning on either the transistor 710 or 711. With the far side electrode held at V_{bias} and the near side electrode held at ground potential, V_{bias} may be ramped up sequentially (i.e., the voltage magnitude may be increased sequentially). The ramping of V_{bias} may permit for the ramping of the resulting electrostatic torque between the micromirror and the electrodes so that it scales as 2ⁱ, where i is a binary bit of the gray scale (or tilt angle). Furthermore, the ramping of V_{bias} may also allow for the scaling of time averaged electrostatic torque to a desired tilt angle. For example, the ramping up of V_{bias} may be expressed as V_{bmax}[2^{i/2}/2^{(N-1)/2}], for 0≦i≦N−1, where N is the number of bits used in representing a gray scale value (or tilt angle) and V_{bmax} is a maximum V_{bias} value. The ramping up of V_{bias} may result in a progressive weighting of the drive waveform that permits the use of N intervals rather than at least 2^{N} intervals when using a pulse-width modulated drive waveform. A discussion of different progressive weighting techniques is provided below. The drive circuit 700 may need additional circuitry, such as memory cells and gates that may be necessary to perform switching, for example. The additional circuitry is not shown in the diagram shown in FIG. 7b. However, the additional circuitry needed should be readily evident to those of ordinary skill in the art.

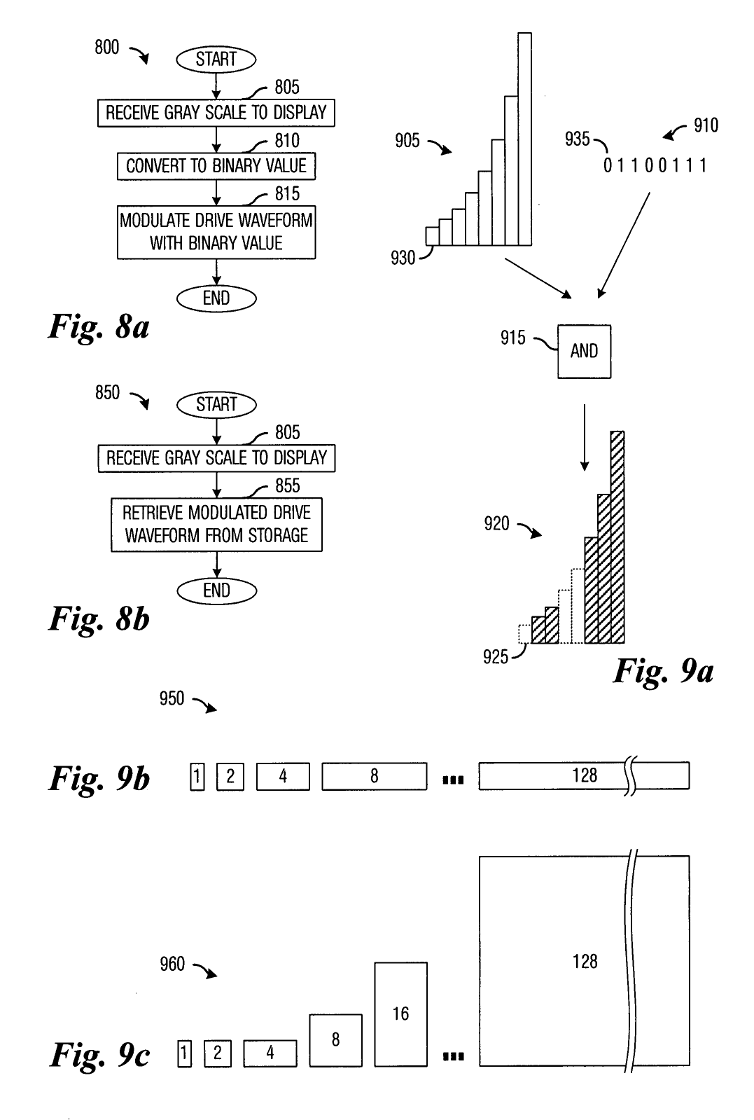

With reference now to FIGS. 8a and 8b, there are shown diagrams illustrating algorithms 800 and 850 for use in generating a progressively weighted drive waveform to be used in controlling micromirror position. The algorithm 800 may execute in a controller, such as the controller 640, of a system, such as the system 600 or 650, containing one or more DDMDs. The controller 640 may be configured to continuously execute the algorithm 800 when the system 600 is in a normal operating mode. The controller 640 may begin when it receives a gray scale to display (block 805). The gray scale may be intended for one or more micromirrors in a DDMD of the system 600. For example, each individual micromirror in a DDMD may receive a potentially different gray scale to display. In a system not for use in displaying images or holograms, a value specifying a desired position of a micromirror may be received rather than a gray scale.

After receiving the gray scale, the controller 640 may convert the gray scale into a binary (a power of two representation) value or perform a lookup in a data storage space to determine a binary value representative of the gray scale (block 810). Alternatively, some other representation of the gray scale may be determined, such as a ternary (power of three), quaternary (power of four), and so forth. Then, the controller 640 may use the binary representation of the gray scale to modulate a drive waveform (block 815). For example, in a pulse amplitude modulated drive waveform, the modulation may be as simple as gating a default drive waveform. If an i-th bit of the binary representation of the gray scale is equal to zero, then the controller 640 may gate (block or eliminate) a portion of the drive waveform associated with the i-th bit and if an i-th bit is equal to one, then the controller 640 pass (enable) a portion of the drive waveform associated with the i-th bit.

In algorithm 850, the controller 640 executing the algorithm 850 may retrieve a modulated drive waveform from storage (block 855) after receiving the gray scale to display (block 805). The storage may be a memory coupled to the controller and may be arranged in a form of a lookup table to enable rapid retrieval of the modulated drive waveform. In an alternative embodiment, the controller 640 may retrieve a description of the modulated drive waveform or a set of control instructions that may be utilized to generate the modulated drive waveform.

The algorithm 800 and/or the algorithm 850 may be modified to implement an adaptive scheme for moving a micromirror. During the initial stages of moving a micromirror, the algorithm 800 and/or the algorithm 850 may be adjusted to scale up the gray scale converted to a binary value (block 810) to display or retrieved from storage (block 855). Then, as the micromirror moves closer to a desired tilt angle, as detected using the sensor array 635, the algorithm 800 and/or the algorithm 850 may scale down the gray scale. The scaling of the gray scale may occur in discrete steps with abrupt reductions as the micromirror approaches the desired tilt angle or continuously with a gradual reduction in the gray scale as the micromirror approaches the desired tilt angle. Once the micromirror reaches the desired tilt angle, the gray scale may be set to be about equal to the gray scale received in block 805 and held at that value until a new gray scale is received. The order of the events in the algorithm 800 and the algorithm 850 may be changed, the algorithm may be performed in a different order, or some of the steps may be performed at the same time without affecting the algorithms.

With reference now to FIGS. 9a through 9c, there are shown diagrams illustrating the modulation of a drive waveform with a binary representation of a gray scale and of alternative drive waveforms. The diagram shown in FIG. 9a illustrates the modulation of a drive waveform 905 as described above by a binary sequence 910 “0 1 1 0 0 1 1 1,” which may be a binary representation of a gray scale. The controller 640 may perform a logical AND (AND unit 915) of the drive waveform 905 and the binary sequence 910. The AND unit 915 may perform a logical AND of a drive value associated with a least significant bit with a least significant bit of the binary sequence 910, for example. This may be repeated for every bit value of the binary sequence 910, producing a modulated drive sequence 920. For example, a least significant drive value 925 of the modulated drive sequence 920 may be a result of an ANDing of a least significant drive value 930 of the drive sequence 905 and a least significant bit 935 of the binary sequence 910. The least significant drive value 925 is shown as a hollow, dashed box to represent a zeroed value.

Alternatively, rather than ANDing, the drive waveform 905 and the binary sequence 910 may be modulated through the use of a drive gate. As the drive waveform 905 is stepped, the binary sequence 910 may be shifted in synchrony with the stepping of the drive waveform 905 into the drive gate. Then, if a particular binary value of the binary sequence 910 is a one (1), then the associated drive waveform 905 may be provided to the micromirror, while if the particular binary value of the binary sequence 910 is a zero (0), then the associated drive waveform 905 is not provided to the micromirror. The modulated drive waveform may be continually provided to the micromirror until a new gray scale is provided to the system 600 or until the micromirror reaches a position associated with the gray scale (detected through the use of the optical feedback circuit, for example).

Rather than increasing the voltage magnitude (therefore the current magnitude) based on the weighting of bits of the gray scale while maintaining a constant voltage on time (and therefore the current on time), the controller 640 may increase the voltage on time based on the weighting of bits of the gray scale while maintaining a constant voltage magnitude. The diagram shown in FIG. 9b illustrates a drive waveform 950 wherein voltage on time is increased as the weight of an associated bit of the gray scale is increased. The voltage on time may be expressed as Timeₘₐₓ[2^{i/2}/2^{(N-1)/2}] for 0≦i≦N−1, where N is the number of bits used in the binary number, and Timeₘₐₓ is a maximum voltage on time, for example.

In an alternative to changing either the voltage magnitude or the voltage on time, it may be possible for the controller 640 to change both the voltage on time and the voltage magnitude based on the weighting of bits of the gray scale. The diagram shown in FIG. 9c illustrates a drive waveform 960 wherein voltage on time and voltage magnitude is increased as the weight of an associated bit of the gray scale is increased. Either the voltage on time or the voltage magnitude or both may be increased as the weight of an associated bit of the gray scale is increased. An advantage of increasing voltage magnitude is that voltage on time may be shortened. With an extended voltage on time, long pulse periods may arise, which may have more ripple in the waveforms. This may lead to increased movement of the micromirrors about their equilibrium positions.

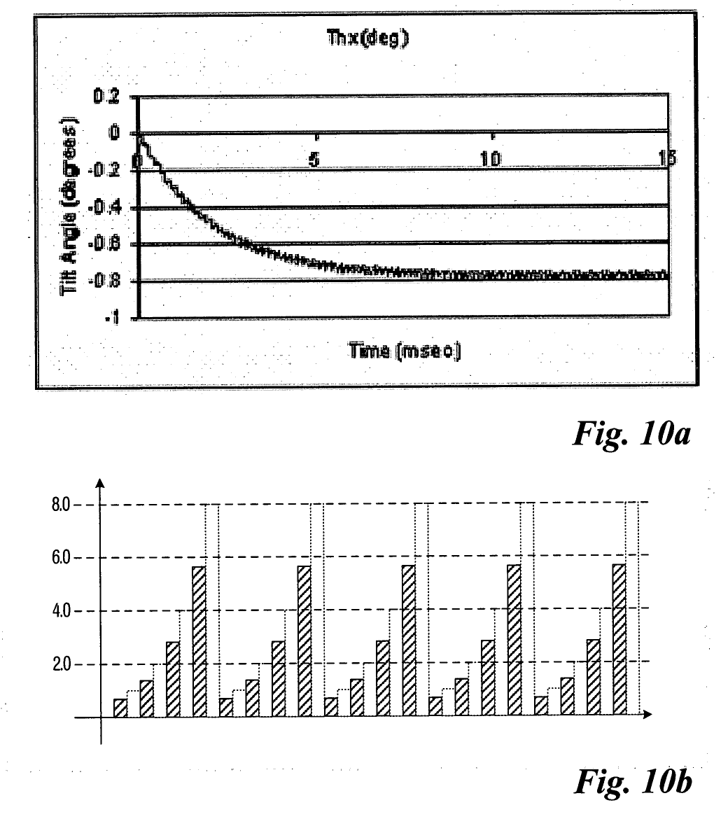

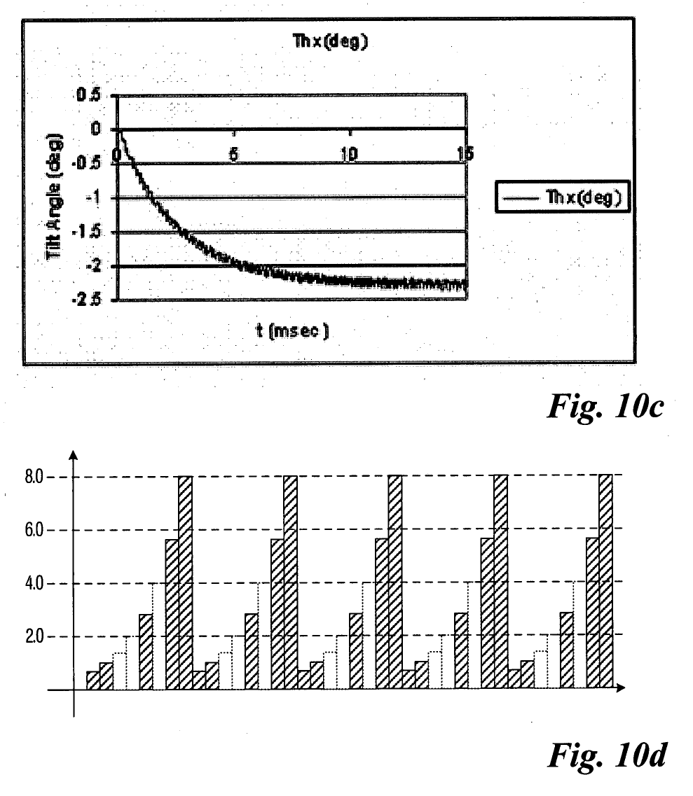

With reference now to FIGS. 10a through 10d, there are shown diagrams illustrating micromirror response and modulated drive waveforms for exemplary gray scales for a computer model of an exemplary DDMD. The diagram shown in FIG. 10a illustrates a micromirror response (micromirror tilt angle version time) with the micromirror being driven by a modulated drive waveform for a gray scale with a binary value of 0 1 0 1 0 1 0 1. The diagram shown in FIG. 10b illustrates several cycles of the modulated drive waveform for a gray scale with a binary value of 0 1 0 1 0 1 0 1. The diagrams shown in FIG. 10c and FIG. 10d illustrate micromirror response and multiple cycles of the modulated drive waveform for a gray scale with a binary value of 1 1 0 1 0 0 1 1. Each time a micromirror of the DDMD may be driven by a single cycle of the modulated drive waveform as shown in FIG. 10b and FIG. 10d, a small change in the micromirror's tilt angle may result. This may be seen in the diagrams shown in FIG. 10a and FIG. 10c as the ripples present in traces illustrating micromirror response. The two different modulated drive waveforms, shown in FIG. 10b and FIG. 10d, may have different effects on the steady state tilt angle of a micromirror of the DDMD.

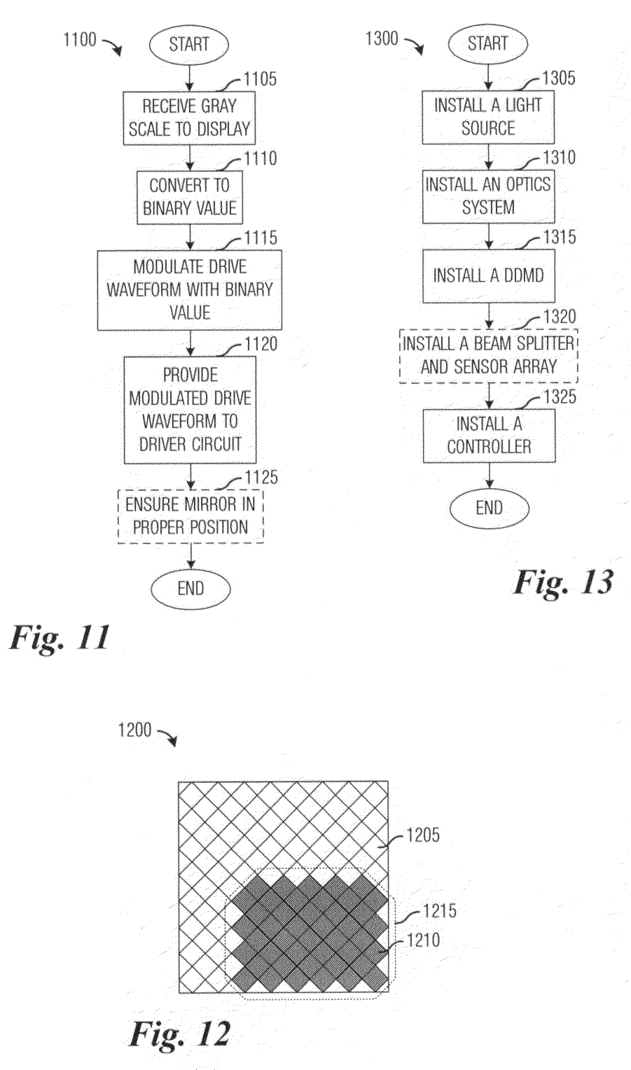

With reference now to FIG. 11, there is shown a diagram illustrating an algorithm 1100 for use in moving a micromirror to a position specified by a gray scale. The algorithm 1100 may execute in a controller, such as the controller 640, of a system, such as the system 600 or 650, containing one or more DDMD. The controller 640 may be configured to continuously execute the algorithm 1100 when the system 600 is in a normal operating mode. The controller 640 may begin when it receives a gray scale to display (block 1105). The gray scale may be intended for one or more micromirrors in a DDMD of the system 600. For example, each individual micromirror in a DDMD may receive a potentially different gray scale to display. In a system not for use in displaying images or holograms, a value specifying a desired position of a micromirror may be received rather than a gray scale.

After receiving the gray scale, the controller 640 may convert the gray scale into a binary value or perform a lookup in a data storage space to determine a binary value representative of the gray scale (block 1110). Then, the controller 640 may use the binary representation of the gray scale to modulate a drive waveform (block 1115). For example, in a pulse amplitude modulated drive waveform, the modulation may be as simple as gating a default drive waveform. If an i-th bit of the binary representation of the gray scale is equal to zero, then the controller 640 may gate (block or eliminate) a portion of the drive waveform associated with the i-th bit and if an i-th bit is equal to one, then the controller 640 pass (enable) a portion of the drive waveform associated with the i-th bit.

The controller 640 may provide the modulated drive waveform to the driver circuit 700 (block 1120). Alternatively, the controller 640 may provide to the driver circuit 700 control instructions necessary for the driver circuit 700 to create the modulated drive waveform. The controller may either provide the modulated drive waveform or the control instructions continuously until the controller 640 receives another gray scale to display. Alternatively, the driver circuit 700 may be configured to continuously create the modulated drive waveform from the control instructions that it receives from the controller 640. After providing the modulated drive waveform to the drive circuit 700, if the system 600 includes an optical micromirror position feedback circuit, the controller 640 may optionally make use of the optical feedback information to ensure that the micromirror is in a proper position based on the gray scale (block 1125). If the micromirror is not in the proper position, the controller 640 may cause the drive circuit 700 to continue to provide an adjusted modulated drive waveform to the DDMD to help ensure that the micromirror is moved to the proper position.

Should the system 600 not include an optical micromirror position feedback circuit, the controller 640 may simply continue to provide the modulated drive waveform to the driver circuit 700 (block 1120) until a new gray scale to display is received. By continuing to provide the modulated drive waveform to the driver circuit 700, the modulated drive waveform may be provided to the DDMD in a continuous fashion, ensuring that the micromirror of the DDMD eventually moves to a position consistent with the gray scale to be displayed. Once the micromirror of the DMDD moves to the position consistent with the gray scale to be displayed, the continually provided modulated drive waveform will maintain the micromirror in the position. The order of the events in this algorithm may be changed, the algorithm may be performed in a different order, or some of the steps may be performed at the same time without affecting the algorithm.

With reference now to FIG. 12, there is shown a diagram illustrating a top view of a DDMD 1200. The DDMD 1200 shown in FIG. 12 may be operating in a mixed mode. The DDMD 1200 may include micromirrors operating in several different modes. The DDMD 1200 may include micromirrors, such as micromirror 1205, operating in an analog mode, wherein the micromirrors may be moved to positions (tilt angles) between a first position and a second position, with the positions depend on a modulated drive waveform provided to the micromirrors. The DDMD 1200 may also include micromirrors, such as micromirror 1210, operating in a digital bi-stable mode, wherein the micromirrors may either be in the first position, the second position, or in transition between the first position and the second position.

As shown in FIG. 12, the micromirrors operating in the digital bi-stable mode may comprise a group of micromirrors 1215, while the micromirrors operating in the analog mode may comprise a remainder of the micromirrors of the DDMD 1200. However, any micromirror of the DDMD 1200 may operate in either the analog mode or the digital bi-stable mode, depending on the drive signals being provided to the micromirror. Therefore, there may not be a physical limitation on a distribution of micromirrors operating in a particular mode, with an actual distribution and arrangements of micromirror operating modes being dependent on a desired application of the DDMD 1200.

With reference now to FIG. 13, there is shown a diagram illustrating a sequence of events 1300 in the manufacture of an exemplary display system with a DDMD. The manufacture of the display system may begin with installing a light source (for example, the light source 610), which may produce multiple colors of light (block 1305). The manufacture may continue with installing an optics system, such as collimation/relay optics unit 615 and filter system with optional beam splitter unit 620 (block 1310) and a DDMD, for example, DDMD 605 (block 1315) in the light path of the multiple colors of light produced by the light source (block 1305). The DDMD contains an array of light modulators operating in a damping liquid. The manufacture of the display system may continue with the installation of an optional beam splitter and sensor array (for example, the sensor array 635), which may be a part of a feedback control system (block 1320). A controller, such as the controller 640, for the display system may then be installed in the light path of the multiple colors of light (block 1325). The order of the events in this sequence may be changed, the sequence may be performed in a different order, or some of the steps may be performed at the same time to meet particular manufacturing requirements of the various embodiments of the DDMD, for example.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for controlling a position of a micromirror, the method comprising:
receiving a value, wherein the position is based on the value and the position of the micromirror is between a first stop position and a second stop position;
determining a drive waveform based on the value; and
providing the drive waveform to the micromirror.

2. The method of claim 1, wherein the providing is repeated until a second value is received.

3. The method of claim 1, further comprising after the providing, receiving micromirror position feedback information, and wherein the determining is further based on the micromirror position feedback information.

4. The method of claim 1, wherein the position lies within a range of positions spanned by the first stop position and the second stop position and is inclusive of the first stop position and the second stop position.

5. The method of claim 1, wherein the determining comprises:
converting the value into a binary number; and
combining the binary number with a reference drive waveform.

6. The method of claim 5, wherein the combining comprises:
for each binary value in the binary number,
setting an associated portion of the reference drive waveform to about zero in response to a determining that the binary value is equal to zero, and
leaving unchanged the associated portion of the reference drive waveform in response to a determining that the binary value is equal to one.

7. The method of claim 5, wherein the reference drive waveform comprises N pulses with increasing voltage magnitude, wherein the voltage magnitude is expressible as:
V_{bmax}[2^{i/2}/2^{(N-1)/2}], for 0≦i≦N−1,
where N is the number of bits used in the binary number, and V_{bmax} is a maximum voltage.

8. The method of claim 5, wherein the reference drive waveform comprises N pulses with increasing voltage on time, wherein the voltage on time is expressible as:
Timeₘₐₓ[2^{i/2}/2^{(N-1)/2}], for 0≦i≦N−1,
where N is the number of bits used in the binary number, and Timeₘₐₓ is a maximum voltage on-time.

9. The method of claim 5, wherein the reference drive waveform comprises N pulses with increasing voltage magnitude and voltage on-time.

10. The method of claim 1, wherein the drive waveform is based on a scaled version of the value, and wherein the scaling of the value is reduced as the micromirror moves closer to the tilt angle.

11. A system comprising:
a first damped digital micromirror device (DDMD) optically coupled to a light source and positioned in a light path of the light source, the first DDMD comprising an array of micromirrors operating in a damping liquid, wherein the damping liquid retards the movement of the micromirrors; and
a controller electrically coupled to the first DDMD, the controller configured to provide drive waveforms to individual micromirrors in the first DDMD, wherein a drive waveform moves the micromirrors in the first DDMD to a position between a first stop position and a second stop position.

12. The system of claim 11, further comprising:
a beam splitter optically coupled to the first DDMD and positioned in the light path after the first DDMD, the beam splitter configured to split the light path into a second light path and a third light path; and
a sensor array optically coupled to the beam splitter and positioned in the second light path of the beam splitter and electrically coupled to the controller, the sensor array configured to provide electrical information based on sensed optical information.

13. The system of claim 12, wherein the sensor array provides electrical information related to the positions of the micromirrors in the first DDMD.

14. The system of claim 11, further comprising a second DDMD optically coupled to the light source and positioned in the light path after the first DDMD and electrically coupled to the controller, the second DDMD comprising a second array of micromirrors operating in a second damping liquid, wherein the second damping liquid retards the movement of the micromirrors in the second DDMD.

15. The system of claim 14, further comprising:
a second beam splitter optically coupled to the second DDMD and positioned in the light path after the second DDMD, the beam splitter configured to split the light path into a fourth light path and a fifth light path; and
a second sensor array optically coupled to the second beam splitter and positioned in the fourth light path of the second beam splitter and electrically coupled to the controller, the sensor array configured to provide electrical information based on sensed optical information.

16. The system of claim 14, further comprising:
a filter stop optically coupled to the first DDMD and positioned in the light path after the first DDMD, the filter stop configured to convert linear phase modulated light from the first DDMD into intensity modulated light; and
a spatial filter optically coupled to the second DDMD and positioned in the light path after the second DDMD, the spatial filter configured to eliminate extraneous orders of the intensity modulated light.

17. The system of claim 11, wherein at least one micromirror in the array of micromirrors operates in a bi-stable mode, moving between a first position and a second position, stopping only in either the first position or the second position, and wherein at least another micromirror in the array of micromirrors operates in an analog mode, moving between the first position and the second position, stopping about third position between the first position and the second position.

18. The system of claim 11, wherein the first DDMD comprises micromirrors selected from the group consisting of: tilt-mode micromirrors, sag/piston-mode micromirrors, and combinations thereof.

19. A method of manufacturing a system, the method comprising:
installing a light source;
installing an optics system optically coupled to the light source and in a light path of the light source;
installing a damped digital micromirror device (DDMD) optically coupled to the optics system and in the light path after the optics system, wherein the DDMD comprises an array of micromirrors operating in a damping liquid; and
installing a controller electrically coupled to the DDMD.

20. The method of claim 19, further comprising:
installing a beam splitter optically coupled to the DDMD and in the light path after the DDMD; and
installing a sensor array in a light path of the beam splitter and electrically coupled to the controller.
